(19) United States
(12) Patent Application Publication
(10) Pub. No.: US 2022/0194603 A1
(43) Pub. Date: Jun. 23, 2022

(54) TWIN-TURBINE AIR CONDITIONING SYSTEM

(71) Applicant: LIEBHERR-AEROSPACE TOULOUSE SAS, Toulouse (FR)

(72) Inventors: Frédéric SANCHEZ, Toulouse (FR); David LAVERGNE, Toulouse (FR); Vinciane MILLE, Toulouse (FR)

(21) Appl. No.: 17/601,420

(22) PCT Filed: Mar. 16, 2020
(86) PCT No.: PCT/FR2020/050560

§ 371 Date: Oct. 4, 2021

(30) Foreign Application Priority Data
Apr. 2, 2019 (FR) 1903493

(51) Int. Cl. B64D 13/08

(52) U.S. Cl. CPC B64D 13/08; B64D 2013/064

(57) ABSTRACT

The invention relates to an air conditioning system for an aircraft cabin, comprising two motorized turbomachines (16a, 16b) each comprising a compressor (14a, 14b) supplying an outlet (24) common to the compressors and a turbine, one of the turbines, referred to as water extraction turbine (16a), being dedicated to a water extraction loop (28) and the other turbine, called cooling turbine (16b), helping cool the air.

The air conditioning system comprises a network of pipes and associated valves, connected to the common outlet (24) of the compressors and making it possible to supply, from the common outlet of the compressors:
either the inlet (160) of the water extraction turbine (16a), or the inlet (164) of the cooling turbine (16b), bypassing the turbine (16a) and the water extraction loop,
or an outlet (60) of the air conditioning system directly, bypassing the cooling turbine (16b) and the water extraction turbine (16a).

### TECHNICAL FIELD OF THE INVENTION

The invention relates to an aircraft cabin air conditioning system. In particular, the invention relates to an air conditioning system comprising two motorized turbomachines.

### TECHNICAL BACKGROUND

Throughout the text, the term “cabin” denotes any interior space of an aircraft in which the pressure and/or temperature of the air must be controlled. This may be a cabin for passengers, the pilot's cockpit, a hold, and in general any area of the aircraft that requires air at a controlled pressure and/or temperature. This air at a controlled pressure and/or temperature is supplied by an air conditioning system.

Air conditioning systems comprising motorized turbomachines have particular advantages and are increasingly used in what are known as “more electric aircraft” in which electrical circuits allow the transmission of energy in the aircraft, unlike previous aircraft architectures where most of the transmitted energy came directly from bleed air from the engine(s) or an auxiliary power unit.

In particular, air conditioning systems took part of the air flow passing through the engines after compression, which resulted in a drop in load and a reduction in engine efficiency for the thrust or lift of the aircraft.

An air conditioning system comprising motorized turbomachines allows a pneumatic pressure source to be generated autonomously, in particular by taking non-pressurized outside air via scoops, which has no effect on the performance of the engines.

This pneumatic source is then treated, in particular by means of water extraction and cooling, before distribution in the aircraft cabin via a mixing chamber (or mixer) and a distribution system.

### AIMS OF THE INVENTION

The invention aims to provide a more effective and more efficient air conditioning system.

The invention aims in particular to provide an air conditioning system benefiting from an optimized and compact assembly, with a saving in mass and/or in size.

The invention also aims to provide an air conditioning system that is reliable and that makes it possible to limit the reduced flow rate range between the conditions of the aircraft on the ground or in flight.

The invention also aims to adapt the behavior of the air conditioning system to the flight conditions of the aircraft, and in particular to its altitude.

### DISCLOSURE OF THE INVENTION

To this end, the invention relates to an air conditioning system for an aircraft cabin, comprising:
a first motorized turbomachine, referred to as a water extraction turbomachine, comprising a compressor, a water extraction turbine comprising an outlet and an inlet, and a motor driving the compressor and the water extraction turbine in rotation,
a second motorized turbomachine, referred to as a cooling turbomachine, comprising a compressor, a cooling turbine comprising an inlet and an outlet, and a motor driving the compressor and the cooling turbine in rotation,
a water extraction loop connected to the inlet of the water extraction turbine and comprising a condenser and a water separator,
an outlet from the air conditioning system, configured such that it can be connected to the cabin of the aircraft

the air conditioning system being characterized in that the compressor of the water extraction turbomachine and the compressor of the cooling turbomachine are configured to receive air outside the aircraft and are mounted in parallel so as to be able to feed a common outlet

and in that it comprises a network of pipes and associated valves, connected to the common outlet of the compressors and making it possible to supply, from the common outlet of the compressors:
either the inlet of the water extraction turbine,
or the inlet of the cooling turbine, bypassing the water extraction turbine and the water extraction loop,
or, directly, the outlet of the air conditioning system, bypassing the cooling turbine, the water extraction turbine and the water extraction loop.

The concept of “bypassing” the turbines is understood to mean a bypass function of these turbines making it possible to prevent the passage of air flows through these turbines, advantageously by virtue of bypass valves.

An air conditioning system according to the invention therefore allows better management of the flight conditions of the aircraft, and thus maximizes its performance. The air conditioning system allows more cold power to be produced, in particular by virtue of unencumbered use of the cooling turbine linked to the water extraction turbine. In addition, arranging the compressors in parallel, the outlets of the compressors supplying the common outlet, makes it possible to make the air conditioning system more reliable and allows the reduced flow range to be limited between the conditions of the aircraft on the ground or in flight. The aerodynamic efficiency is improved, which makes it possible to potentially avoid the use of a variable diffuser.

The field of use of the air conditioning system is extended and more flexible owing to the decoupling of the so-called “cold power” function (linked to the cooling turbine allowing the supply of cooled air) and the water extraction function linked to the water extraction turbine.

The use of linked compressors eliminates the need for an external source of pressurized air. In particular, each compressor can ensure the entire supply of air to the air conditioning system, especially if one of the compressors has broken down or if one of the motorized turbomachines is stopped.

All of these advantages allow optimized and compact integration, in particular savings in mass and bulk, by performing the air conditioning functions with a limited number of equipment items while maintaining great flexibility.

In the systems of the prior art, the cooling and water extraction functions are not decoupled, which limits any optimization based on the phases of flight and the climatic conditions. In addition, placing the compressors in series in the systems of the prior art does not allow sufficient reliability, in particular in “more electric” aircraft architectures.

The invention allows a reliable, flexible air conditioning system architecture that easily adapts depending on whether the aircraft is on the ground or in flight, and depending on its altitude.

Advantageously, an air conditioning system according to the invention comprises:
a control module, configured to control the network of pipes and valves according to the altitude of the aircraft and the temperature of the air at the common outlet, to allow supply from the common outlet of the compressors:
   either to the inlet of the water extraction turbine, when the aircraft is on the ground or at low altitude,
   or to the inlet of the cooling turbine directly, bypassing the water extraction turbine and the water extraction loop by opening a first valve, when the aircraft is at medium altitude and/or when the air temperature is greater than a predetermined threshold,
   or to the outlet of the air conditioning system directly, bypassing the cooling turbine, the water extraction turbine and the water extraction loop by opening the first valve and a second valve, when the aircraft is at high altitude and/or when the air temperature is below the predetermined threshold.

According to this variant of the invention, the air conditioning system makes it possible to adapt to the different flight conditions of the aircraft in which it is integrated.

In particular, when the aircraft is on the ground and at low altitude (e.g. below 15,000 feet above sea level), cold power generation and water separation are required and therefore operate nominally, that is to say, the cooling and water extraction turbines are not bypassed.

When the aircraft is at medium altitude (e.g. above 15,000 feet on a hot day and below 25,000 feet), water separation is no longer necessary and is rendered inactive not bypassing the water extraction turbine and the water extraction loop (for example by opening a bypass valve).

When the aircraft is at high altitude (for example above 25,000 feet) and when temperature conditions permit, the cooling turbine can also be bypassed, since the need for cold power is lower because the collected outside air is sufficiently cold.

Advantageously, an air conditioning system according to the invention comprises a pipe connecting the cabin to the inlet of the water extraction turbine and/or the inlet of the cooling turbine.

According to this aspect of the invention, the air leaving the cabin of the aircraft, often called “stale air,” can be recovered to supply the inlet of one of the turbines of the air conditioning system. This allows energy recovery that drives the turbine(s), thus reducing the electrical consumption of the air conditioning system.

This variant of the invention is particularly interesting in that it supplies a turbine when it is bypassed by the air conditioning system, in which case it is no longer used. The stale air supply makes it possible to recover energy to operate the compressors.

Advantageously, an air conditioning system according to the invention comprises at least one exchanger configured to be passed through by air leaving the outlet of the water extraction turbine. This exchanger is preferably part of the cooling water loop, and is typically a condenser/reheater.

Advantageously, an air conditioning system according to the invention comprises at least one fixed blading with variable injection section mounted on the water extraction turbine and/or on the air cooling turbine so as to be able to modify, on command, the air flow supplying an air inlet of the turbine(s) on which the blading is mounted.

The invention also relates to a method for controlling an air conditioning system according to the invention, characterized in that it comprises:
a step in which data representative of the altitude of the aircraft is received,
a step in which data representative of the air temperature at the common compressor outlet is received,
a step in which an operating mode based on the altitude of the aircraft and the temperature of the air at the common compressor outlet, is selected from:
   a first operating mode when the altitude of the aircraft is below a first predetermined threshold, in which the network of pipes and valves is configured to connect the common outlet to the water extraction turbine;
   a second operating mode when the altitude of the aircraft is greater than the first predetermined threshold and less than a second predetermined threshold, and/or when the air temperature is greater than a predetermined threshold, in which the network of pipes and valves is configured to connect the common outlet to the cooling turbine, bypassing the water extraction turbine and the water extraction loop;
   a third operating mode when the altitude of the aircraft is greater than the second predetermined threshold or the air temperature is below a predetermined threshold, in which the network of pipes and valves is configured to connect the common outlet to the outlet of the air conditioning system.

The invention also relates to an aircraft comprising a cabin, characterized in that it comprises an air conditioning system according to the invention, said air conditioning system supplying said cabin of the aircraft with air conditioning.

The advantages of an air conditioning system according to the invention apply, mutatis mutandis, to an aircraft according to the invention.

The invention also relates to an air conditioning system, a method of controlling such an air conditioning system, and an aircraft comprising such an air conditioning system, characterized collectively by all or some of the features mentioned above or below.

### LIST OF FIGURES

Further aims, features and advantages of the invention will become apparent upon reading the following description, which is provided solely by way of a non-limiting example, and which refers to the accompanying figures, in which:

FIG. 1 is a schematic view of an air conditioning system according to an embodiment of the invention.

FIG. 2 is a schematic view of a control method according to an embodiment of the invention.

### DETAILED DESCRIPTION OF ONE EMBODIMENT OF THE INVENTION

For the sake of illustration and clarity, scales and proportions are not strictly adhered to in the figures.

Moreover, identical, similar or analogous elements are denoted using the same reference signs throughout the figures.

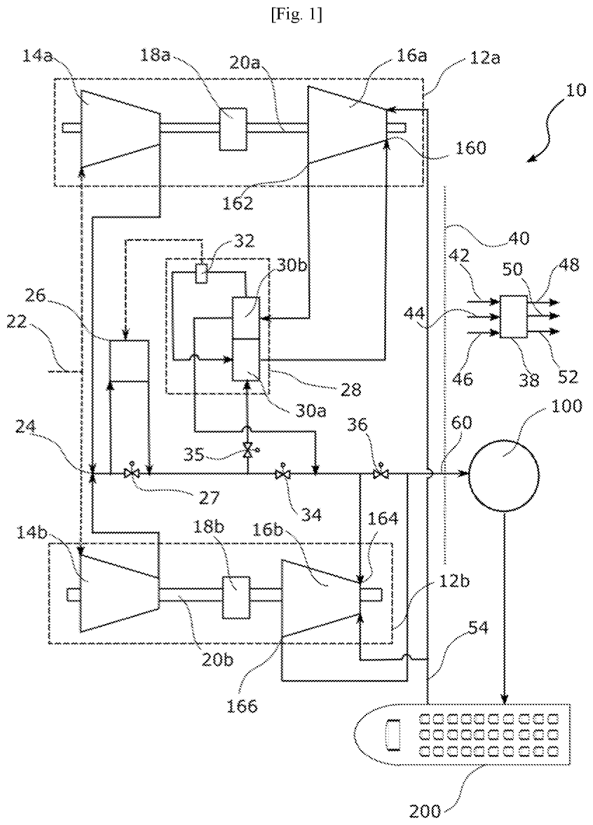

FIG. 1 schematically shows an air conditioning system 10 according to one embodiment of the invention. The air conditioning system comprises an outlet 60, here supplying a mixing chamber or mixer 100 supplying air conditioning to the cabin 200 of an aircraft.

The air conditioning system 10 comprises a first motorized turbomachine, referred to as the water extraction turbomachine 12a, and a second motorized turbomachine, referred to as the cooling turbomachine 12b.

Each motorized turbomachine conventionally comprises a compressor, a turbine and a motor connected on the same shaft, the rotation of these three elements being linked by said shaft. In particular, the motor can generate a torque causing a rotation of the shaft, and thus a rotation of the compressor and of the associated turbine.

In particular, the water extraction turbomachine 12a comprises a compressor 14a, a water extraction turbine 16a and a motor 18a, these elements being linked in rotation by a shaft 20a.

Likewise, the cooling turbomachine 12b comprises a compressor 14b, a cooling turbine 16b and a motor 18b, these elements being linked in rotation by a shaft 20b.

The compressor 14a of the extraction turbomachine 12a and the compressor 14b of the cooling turbomachine 12b have similar functions: the two compressors 14a, 14b receive air 22 outside the aircraft when the motors of the motorized turbomachines drive them in rotation, for example from a scoop arranged on the outer wall of the aircraft. This air is compressed, and the compressed air from the two compressors feeds an outlet 24 that is common to the two compressors. The two compressors are arranged in parallel, each compressor directly feeding the common outlet 24. Each compressor is configured to be able to supply the common outlet 24 on its own, in particular in the event of a failure of one of the two compressors or if one of the two motorized turbomachines is stopped.

The compressed air supplying the common outlet 24 is then treated by the air conditioning system to achieve the temperature, pressure and humidity criteria in order to be able to supply the cabin 200 of the aircraft via the mixer 100. A network of pipes and valves, described below, allows the air to pass through various devices enabling its treatment from the common outlet 24 to the outlet 60 of the air conditioning system, thus making it possible to supply the mixer 100.

First, the air can be conventionally cooled in an exchanger 26 supplied by a dynamic air passage (commonly called “ram air”) of the aircraft. This cooling can be bypassed by a valve 27 if the air temperature is sufficient.

Then, air can be passed through a water extraction loop 28. This water extraction loop 28 comprises a condenser comprising a first heat exchanger 30a and a second heat exchanger 30b configured to cool the compressed air. The compressed air passes through the two exchangers and is thus cooled for the first time, which facilitates the condensation of the water in the air.

At the exchanger outlet, a water separator 32 (or water extractor) allows the quantity of water present in the air to be reduced. For example, this water separator can be of the centrifugal type and allows the recovery of the water, which can be reinjected into the dynamic air to increase the performance of the exchanger 26.

The air from which the water has been extracted passes into the first exchanger 30a to cool the compressed air entering the water extraction loop 28, and reaches an inlet 160 of the water extraction turbine 16a. The air is thus expanded and leaves through an outlet 162 of the water extraction turbine 16a. This expanded air passes through the second exchanger 30b to cool the compressed air entering the water extraction loop 28.

The two exchangers form a condenser/reheater.

The air conditioning system comprises a first bypass valve 34 allowing the water extraction loop 28 and the water extraction turbine 16a to be bypassed if the humidity of the air from the common outlet is low enough.

An optional blocking valve 35 is also present in this embodiment and allows access to the water extraction loop 28 and to the water extraction turbine 16a to be completely blocked. According to another embodiment not described, the first bypass valve 34 and the blocking valve 35 can both be replaced by a single three-way valve, allowing the air flow to be directed either toward the water extraction loop 24, or toward the cooling turbine 16b and/or the outlet 60, with or without blocking access to the water extraction loop 24.

The air coming from the outlet of the water extraction turbine 16a, or directly from the common outlet 24 if the bypass valve 34 is open, can then be directed to an inlet 164 of the cooling turbine 16b to be expanded and cooled again. The air thus expanded and cooled leaves the cooling turbine 16b through an outlet 166 of the cooling turbine.

The outlet 166 of the cooling turbine 16b is connected to the outlet 60 of the air conditioning system, which in turn is connected to the mixer 100 so as to allow the supply of conditioned air to the aircraft cabin 200.

The air conditioning system comprises a second bypass valve 36 allowing the cooling turbine 16b to be bypassed if the temperature of the air from the common outlet is low enough.

Thus, if the air supplied by the compressors at the common outlet 24 has the right temperature and humidity conditions, and possibly pressure conditions or other parameters, the first bypass valve 34 and the second bypass valve 36 can be opened and the common outlet 24 is directly connected to the outlet 60 of the air conditioning system.

The conditions for opening or closing these bypass valves are managed by a control module 38. The control module, like the mixer 100, is generally placed in the pressurized zone of the aircraft, while the rest of the air conditioning system 10 is placed in a non-pressurized zone. The border between the pressurized zone and the non-pressurized zone is symbolized by the dotted line 40.

The control module 38 receives a multitude of information from sensors (not shown) in the air conditioning system, in particular from sensors providing:
information 42 or data representative of the air temperature at the common outlet,
information 44 or data representative of the humidity of the air at the common outlet,
information 46 or data representative of the altitude of the aircraft,
and other information or data that may be relevant for controlling the air conditioning system.

Based on these data, the control module 38 can send control signals for opening or closing valves, and in particular can send:
a control signal 48 to the valve 27,
a control signal 50 to the first bypass valve 34,
a control signal 52 to the second bypass valve 36.

To manage the sending of the signals, the control module 38 can follow a preprogrammed control method.

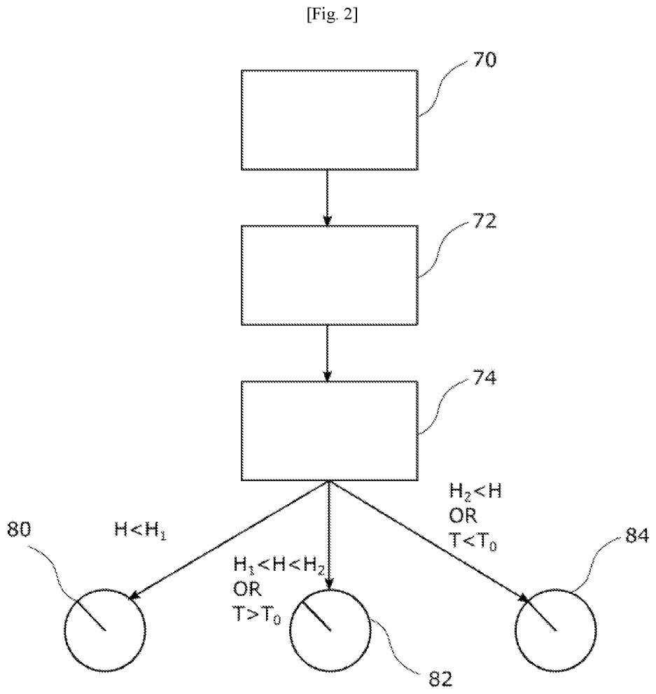

For example, a control method according to one embodiment of the invention, as shown in FIG. 2, can comprise:
a step 70 in which data representative of the altitude of the aircraft is received,
a step 72 in which data representative of the air temperature at the common compressor outlet is received,
a step 74 in which an operating mode based on the altitude of the aircraft and the temperature of the outside air is selected from:
   a first operating mode 80 when the altitude of the aircraft is below a first predetermined threshold H₁, in which the network of pipes and valves is configured to connect the common outlet to the water extraction turbine;
   a second operating mode 82 when the altitude of the aircraft is greater than the first predetermined threshold H₁ and less than a second predetermined threshold H₂, or when the air temperature is greater than a predetermined threshold, in which the network of pipes and valves is configured to connect the common outlet to the cooling turbine, bypassing the water extraction turbine and the water extraction loop;
   a third operating mode 84 when the altitude of the aircraft is greater than the second predetermined threshold or the air temperature is below a predetermined threshold, in which the network of pipes and valves is configured to connect the common outlet to the outlet of the air conditioning system.

In this embodiment, the air leaving the aircraft cabin 200, often called “stale air,” can be recovered to supply the inlet of one or more of the turbines of the air conditioning system, for example here the inlet 164 of the cooling turbine 16b and the inlet 160 of the water extraction turbine 16A, via a pipe 54. This allows energy recovery that drives the turbine(s) when they are not being used for their respective cooling or water extraction function, thus reducing the electrical consumption of the air conditioning system.

1. An aircraft cabin air conditioning system, comprising:
a first motorized turbomachine, referred to as a water extraction turbomachine, comprising a compressor, a water extraction turbine comprising an outlet and an inlet, and a motor driving the compressor and the water extraction turbine in rotation,
a second motorized turbomachine, referred to as a cooling turbomachine, comprising a compressor, a cooling turbine comprising an inlet and an outlet, and a motor driving the compressor and the cooling turbine in rotation,
a water extraction loop connected to the inlet of the water extraction turbine and comprising a condenser and a water separator, and
an outlet from the air conditioning system, configured such that it can be connected to the cabin of the aircraft, wherein
the compressor of the water extraction turbomachine and the compressor of the cooling turbomachine are configured to receive air outside the aircraft and are mounted in parallel so as to be able to feed a common outlet,
the water extraction turbine and the cooling turbine are mounted in series such that the outlet of the water extraction turbine is fluidly connected to the inlet of the cooling turbine, and the outlet of the cooling turbine is connected to the outlet of the air conditioning system, and
the system comprises a network of pipes and associated valves, fluidly connected to the common outlet of the compressors and making it possible to supply, from the common outlet of the compressors:
either the inlet of the water extraction turbine,
or the inlet of the cooling turbine, bypassing the water extraction turbine and the water extraction loop,
or, directly, the outlet of the air conditioning system, bypassing the cooling turbine, the water extraction turbine and the water extraction loop.

2. The a conditioning system according to claim 1, further comprising:
a control module, configured to control the network of pipes and valves according to the altitude of the aircraft and the temperature of the air at the common outlet, to allow supply from the common outlet of the compressors:
either to the inlet of the water extraction turbine, when the aircraft is on the ground or at low altitude,
or to the inlet of the cooling turbine directly, bypassing the water extraction turbine and the water extraction loop by opening a first valve, when the aircraft is at medium altitude and/or when the air temperature is greater than a predetermined threshold,
or to the outlet of the air conditioning system directly, bypassing the cooling turbine, the water extraction turbine and the water extraction loop by opening the first valve and a second valve, when the aircraft is at high altitude and/or when the air temperature is below the predetermined threshold.

3. The air conditioning system according to claim 1, further comprising a pipe connecting the cabin to the inlet of the water extraction turbine and/or the inlet of the cooling turbine, so as to supply the turbine(s) with air, called stale air, expelled from said cabin.

4. The air conditioning system according to claim 1, further comprising at least one exchanger configured to be passed through by air leaving the outlet of the water extraction turbine.

5. The air conditioning system according to claim 1, further comprising at least one fixed blading with variable injection section mounted on the water extraction turbine and/or on the air cooling turbine so as to be able to modify, on command, the air flow supplying an air inlet of the turbine(s) on which the blading is mounted.

6. A method for controlling an air conditioning system that includes a first motorized turbomachine, referred to as a water extraction turbomachine, comprising a compressor, a water extraction turbine comprising an outlet and an inlet, and a motor driving the compressor and the water extraction turbine in rotation,
a second motorized turbomachine, referred to as a cooling turbomachine, comprising a compressor, a cooling turbine comprising an inlet and an outlet, and a motor driving the compressor and the cooling turbine in rotation,
a water extraction loop connected to the inlet of the water extraction turbine and comprising a condenser and a water separator, and
an outlet from the air conditioning system, configured such that it can be connected to the cabin of the aircraft, wherein
the compressor of the water extraction turbomachine and the compressor of the cooling turbomachine are configured to receive air outside the aircraft and are mounted in parallel so as to be able to feed a common outlet,
the water extraction turbine and the cooling turbine are mounted in series such that the outlet of the water extraction turbine is fluidly connected to the inlet of the cooling turbine , and the outlet of the cooling turbine is connected to the outlet of the air conditioning system, and
the system comprises a network of pipes and associated valves, fluidly connected to the common outlet of the compressors and making it possible to supply, from the common outlet of the compressors:
either the inlet of the water extraction turbine,
or the inlet of the cooling turbine, bypassing the water extraction turbine and the water extraction loop,
or, directly, the outlet of the air conditioning system, bypassing the cooling turbine, the water extraction turbine and the water extraction loop comprising:
a step in which data representative of the altitude of the aircraft is received,
a step in which data representative of the air temperature at the common compressor outlet is received,
a step in which an operating mode based on the altitude of the aircraft and the temperature of the air at the common compressor outlet is selected from:
a first operating mode when the altitude of the aircraft is below a first predetermined threshold, in which the network of pipes and valves is configured to connect the common outlet to the water extraction turbine;
a second operating mode when the altitude of the aircraft is greater than the first predetermined threshold and less than a second predetermined threshold, and/or when the air temperature is greater than a predetermined threshold, in which the network of pipes and valves is configured to connect the common outlet to the cooling turbine, bypassing the water extraction turbine and the water extraction loop;
a third operating mode when the altitude of the aircraft is greater than the second predetermined threshold or the air temperature is below a predetermined threshold, in which the network of pipes and valves is configured to connect the common outlet to the outlet of the air conditioning system.

7. An aircraft comprising a cabin characterized in that the aircraft comprises an air conditioning system, said air conditioning system supplying said cabin of the aircraft with air conditioning, said air conditioning system comprising:
a first motorized turbomachine, referred to as a water extraction turbomachine, comprising a compressor, a water extraction turbine comprising an outlet and an inlet, and a motor driving the compressor and the water extraction turbine in rotation.,
a second motorized turbomachine, referred to as a cooling turbomachine, comprising a compressor, a cooling turbine comprising an inlet and an outlet, and a motor driving the compressor and the cooling turbine in rotation,
a water extraction loop connected to the inlet of the water extraction turbine and comprising a condenser and a water separator, and
an outlet from the air conditioning system, configured such that it can be connected to the cabin of the aircraft, wherein
the compressor of the water extraction turbomachine and the compressor of the cooling turbomachine are configured to receive air outside the aircraft and are mounted in parallel so as to be able to feed a common outlet,
the water extraction turbine and the cooling turbine are mounted in series such that the outlet of the water extraction turbine is fluidly connected to the inlet of the cooling turbine , and the outlet of the cooling turbine is connected to the outlet of the air conditioning system, and
the system comprises a network of pipes and associated valves, fluidly connected to the common outlet of the compressors and making it possible to supply, from the common outlet of the compressors:
either the inlet of the water extraction turbine,
or the inlet of the cooling turbine, bypassing the water extraction turbine and the water extraction loop,
or, directly, the outlet of the air conditioning system, bypassing the cooling turbine, the water extraction turbine and the water extraction loop.
